(19) United States
(12) Patent Application Publication
(10) Pub. No.: US 2007/0290815 A1
(43) Pub. Date: Dec. 20, 2007

(54) Utilizing a mapping engine to dynamically map data objects on read/write RFID tags based on customized tag structures

(75) Inventor: Michael Delis, Montreal (CA)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(73) Assignee: SAP AG

(21) Appl. No.: 11/443,352

(22) Filed: May 31, 2006

(51) Int. Cl. H04Q 5/22

(52) U.S. Cl. 340/10.41; 340/572.1; 340/10.1; 716/1; 340/10.51

(57) ABSTRACT

A method and system for enabling a user to customize tag structures for read/write RFID tags to address specific business needs is provided. An initial tag structure tailored to the user's basic needs is provided initially. Also provided is an RFID enhancement guide attachment having, for example, guidelines, syntaxes, and examples for tag structure definition, which the user may utilize to modify or override at least some portions of the provided initial tag structure. A mapping engine may interpret and map to tag objects on an RFID tag based on the customized tag structure to facilitate performance of reading, writing, and other activities associated with the tag objects.

### TECHNICAL FIELD

The technical field of the invention relates in general to radio frequency identification (RFID). More particularly, the technical field of the invention relates to utilizing a mapping engine to dynamically map data objects on read/write RFID tags based on customized tag structures.

### BACKGROUND

Radio frequency identification (RFID) technology is a wireless data collection technology that uses electronic tags for storing data. Unlike bar codes, which must be scanned directly facing a scanner, RFID tags may be read in proximity of a transmitted radio signal. Today, RFID is being used at an unprecedented rate by manufacturers, retailers, logistics providers, and other users to replace or supplement a variety of traditional data processing/management systems. Most notably, RFID technology has often been incorporated into supply chain management systems to facilitate tracking, securing, and managing of items from manufacturing to retail.

At a high level, an RFID system works by enabling a wireless exchange of information between a tagged object and a reader/writer, which in turn allows a host to process the information associated with the tagged object. FIG. 1 illustrates one example of a typical RFID system. In this illustration, a typical RFID system 100 includes three basic components (i.e., tag 102, read/write device 110, and host 116). On the one end, one or more tags or transponders 102 are deposited on an item, which is to be tracked. The tracked Item may be any suitable item upon which an RFID tag may be attached or otherwise integrated. The tags 102 may store information associated with the tracked item and, when inquired by read/write device 110, may communicate that information to read/write device 110 through a radio signal.

The tags 102 may vary in shapes, sizes, and materials as understood by those skilled in the art to suit the conditions of the tracked item and the needs of the user. Each tag 102 typically includes two components, a computer chip 106 and an antenna 108. Appropriate information associated with the tagged item, including, for example, item name, description, price, or any other suitable item-related information, may be stored on the computer chip 106.

Depending on the application, the tags 102 may be passive, active, or battery-assisted. Passive tags generally utilize the power derived from the signals sent by a reader to respond to the reader. Active tags may power their transmissions with an attached battery. Battery-assisted tags may use an attached battery for powering chip electronics, but not transmission. Currently, the less costly passive tags are most frequently used in supply chain management systems.

Functionally, tags 102 typically fall into two categories, read-only or read/write. Read-only tags are programmed with a fixed set of information during manufacturing, which cannot be altered at a later time. Read/write tags, on the other hand, allow writing and/or rewriting of information on the tags by an authorized user or system.

One or more read/write devices or interrogators 110 may be used to communicate with the tags 102. The read/write device 110 may include an antenna 112, a transceiver 114, and any other suitable components for facilitating reading and writing to tags 102. Typically, to facilitate communication with a particular tag or set of tags 102, the read/write device 110 sends out a signal in the frequency tuned to by the targeted tags 102 through transceiver 114 and antenna 112. In response to receiving the signal, the targeted tags 102 respond by transmitting their stored data. Upon receiving the data transmitted by the tags 102, the reader/writer 110 decodes the data and may transfer the data to a host computer system 116 for processing. It is possible for the reader/writer 110 to be either fixed in its position or portable. The reader/writer 110 may also be either wired or wireless.

Host 116 may be any suitable application and/or software provided on any system capable of supporting such application and/or software for processing information obtained from read/write device 110. In some suitable arrangements, a mapping engine may be incorporated into host 116 to coordinate and provide access to information stored on tags 102, for example, through instructions to read/write device 110. Examples of suitable systems, software, and/or applications will be explained in more details below.

An RFID system provides many advantages over traditional tracking and inventory systems that utilize code-based technologies (e.g., bar code). Most notably, RFID utilizes radio frequency for communication and, therefore, may communicate with multiple tags positioned out of sight. Code-based technologies often require a user to physically scan codes associated with each item at close proximity. In addition, much more information may be stored on an RFID tag than on a code-based device. This increased capacity provides a broad range of opportunities for more sophisticated information processing in connection with the tracked items. The read/write tags have the added advantages of being reusable and modifiable, which reduce replacement cost and allow more accurate and flexible association of information with the tracked items.

With flexibility, however, comes complexity, especially when the writable tag is encoded with a user-definable language such as extended-markup-language (XML). Such user-definable language may allow a variety of information formats to be written to the tag. Without proper organization, structure, and appropriate read/write rules, the flexibility in writing data to an RFID tag may create errors and cause confusion during operation.

One known solution to such a problem is for a user to restrict writing/rewriting of information on a tag to a narrowly defined set of formats during manufacturing. For example, the user may create a product id data object on the tag and restrict the data object to holding ids of three digits. While this approach may minimize errors in identification and access of writable data objects on a tag, it limits the reusability and adaptability of the tag. For example, the product line associated with the tag may be expanded to require identification numbers beyond three digits. If the writable tags associated with each product can accept only three digits, the tags must be replaced or individually defined again, which may be costly and time consuming.

In view of the above, a need exists for a user-customizable tag structure for defining data objects on read/write RFID tags, where the tag structure may be easily modified and/or updated. An additional need exists for an improved way of utilizing the above customizable data structure to dynamically interpreting and mapping to data objects on read/write tags thus facilitating easy reading and writing of appropriate information to the tags.

### SUMMARY

Consistent with the principles of the present disclosure, a method and system enables a user to customize tag structures for defining data objects on read/write RFID tags to address specific business needs.

An initial tag structure that is, for example, preliminarily tailored to address the user's basic business needs, may be provided. In one suitable arrangement, the initial tag structure may be provided, for example, in an installation file associated with a business application.

Concurrently with or subsequent to the provision of the initial tag structure, a set of enhancement guidelines for assisting the user to customize the initial tag structure may be provided. The set of enhancement guidelines may include, for example, formats, syntaxes, and examples for tag structure definition.

The user may be allowed to customize the initial tag structure based on the set of enhancement guidelines, for example, to provide detailed specifications of data structure and data schema on RFID tags, including RFID data size, type, encoding, and/or any other suitable information. The user may further be allowed to specify a business object data model in which particular business objects that are unique to the user's business are defined. The business object data model may include both top-level business objects and various item-level business objects associated with each of the top-level business objects.

Dynamic mapping to data objects on the read/write RFID tag may be performed, for example, by a mapping engine, based on the customized tag structure and the user-defined business object data model to facilitate at least one of reading and writing to at least one data object.

Further features and embodiments of the present disclosure will become apparent from the description and the accompanying drawings. It will be understood that the features mentioned above and those described hereinafter may be used not only in the combination specified but also in other combinations or on their own, without departing from the scope of the present disclosure. It will also be understood that the foregoing background, summary, and the following description of the systems consistent with the principles of the present disclosure are in no way limiting on the scope of the present disclosure and are merely illustrations of an embodiment of the present disclosure.

### BRIEF DESCRIPTION OF THE DRAWINGS

Referring now to the drawings, in which like numerals represent like elements throughout the several Figures, aspects of the present disclosure and the exemplary operating environment are described.

FIG. 1 is a block diagram of an illustrative RFID system for facilitating reading and writing to a read/write RFID tag.

FIG. 2 is a flowchart of illustrative steps involved in allowing a user to customize tag structures for read/write RFID tags and dynamically mapping to data objects on the tags based on the customized tag structures.

FIG. 3 is a block diagram of an exemplary initial tag structure file that may be provided to a user.

FIG. 4 is a block diagram of an exemplary customized tag structure file for enhancing an initial tag structure.

FIG. 4a shows illustrative top level business objects in a user-defined business object data model.

FIG. 4b-4d shows illustrative item level-business objects associated with top-level business objects.

FIG. 4e shows an exemplary business object data model file.

FIG. 4f shows an expanded exemplary business object data model file.

FIGS. 5, 7, 9, 11, 13, 15, and 17 each shows exemplary syntax definitions for allowing user customization of a tag object.

FIGS. 6, 8, 10, 12, 14, 16, and 18 each shows examples of specific user-definitions of data objects based on the exemplary syntax definitions of FIGS. 5, 7, 9, 11, 13, 15, and 17, respectively.

FIG. 19 is a block diagram of an illustrative computer system for implementing a software application consistent with the principles of the present disclosure.

FIG. 20 is a block diagram of another illustrative computer system for implementing a software application consistent with the principles of the present disclosure.

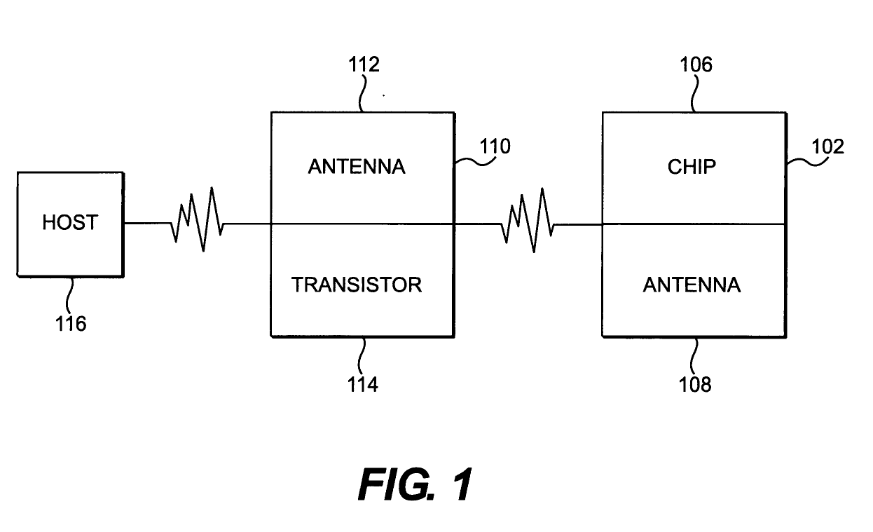

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims and equivalents.

Consistent with the principles of the present disclosure, a method and system enables a user to customize tag structures for read/write RFID tags to address specific business needs. Implementation of the customizable tag structure may be initiated by providing the user with an initial tag structure, for example, in an installation file associated with a business application. The initial tag structure may be tailored to the user's basic needs. The user may then customize the provided initial tag structure file and through it the RFID read/write tag structure to further match its needs and processes.

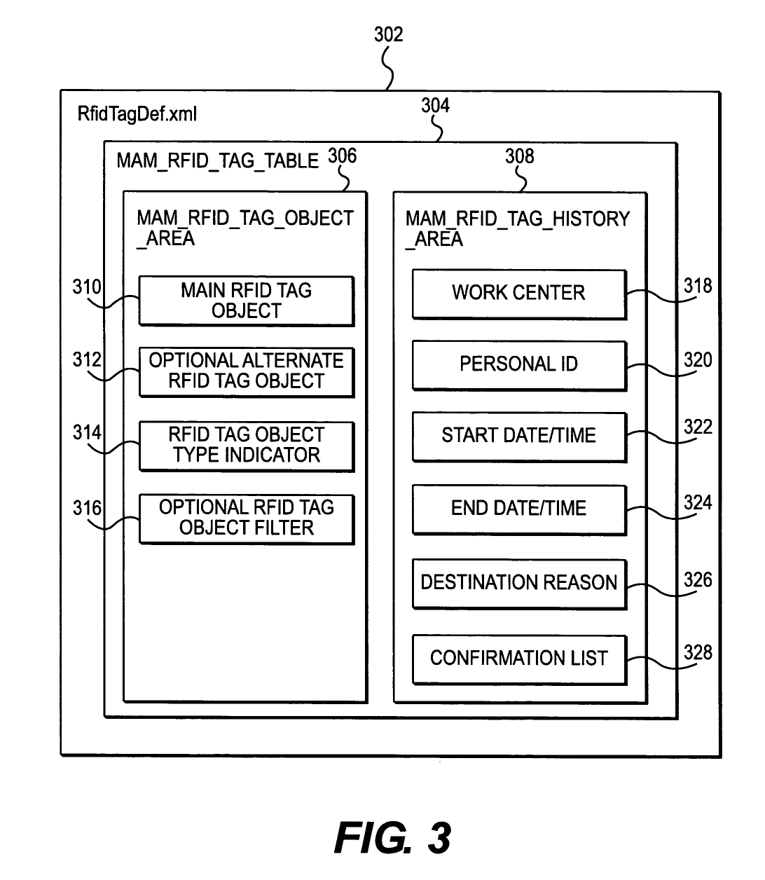

The initial tag structure file may be distributed as a part of a software package, as an add-on to a user application, as a downloadable application enhancement, or as any other suitable form of deliverable appropriate for such a file according to known technologies and techniques. An example of such an initial tag structure file is described in more detail in connection with FIG. 3 below.

For conciseness, the read/write tags will be discussed as being encoded in extensible markup-language (XML). However, it will be understood that any other suitable language for tag definition may be used. The user may customize the provided initial tag structure file and through it the RFID read/write tag structure to more particularly match its specific business needs and processes.

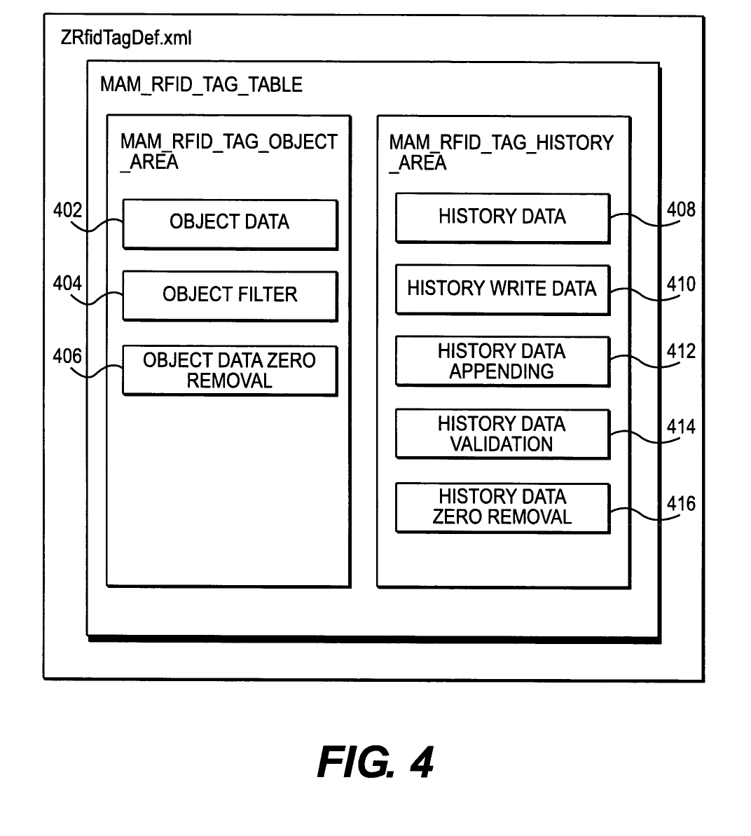

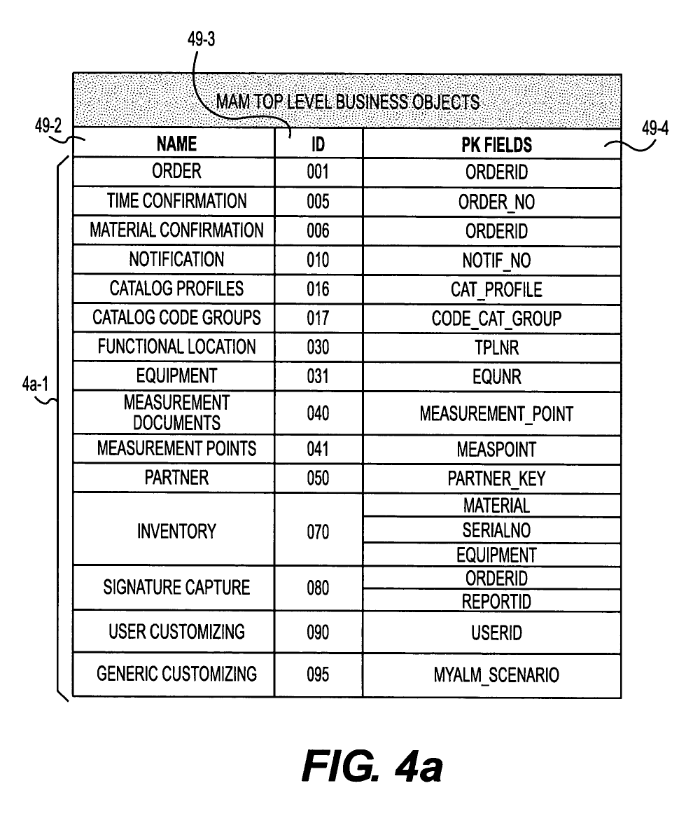

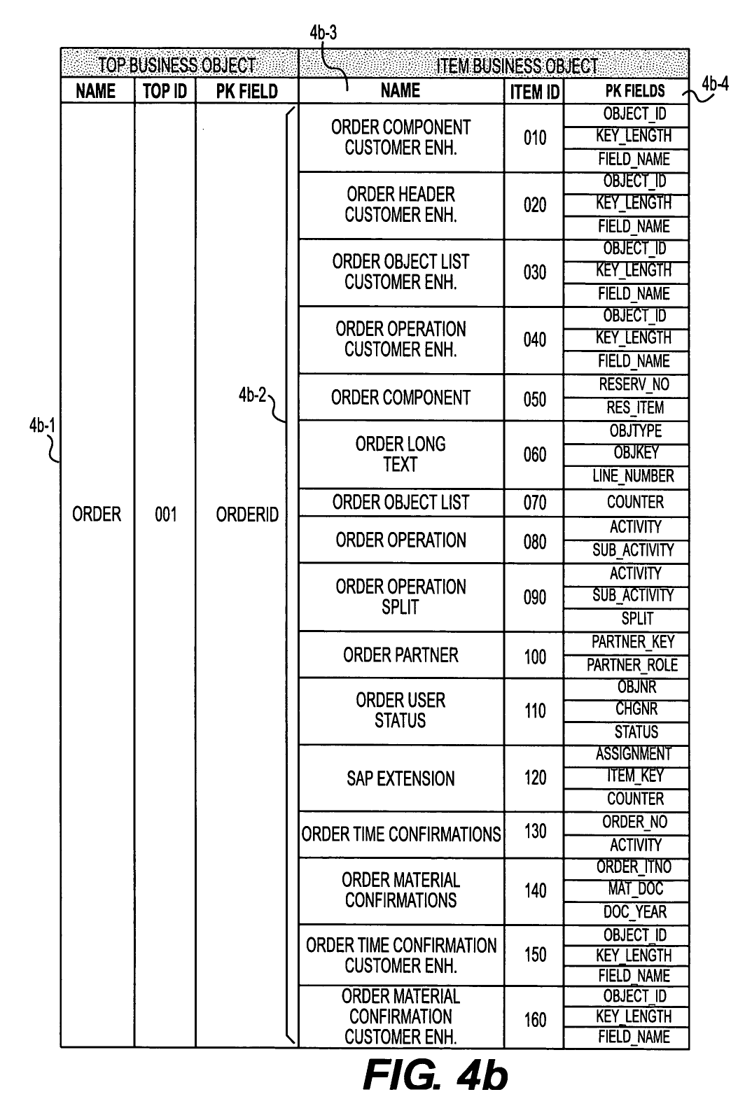

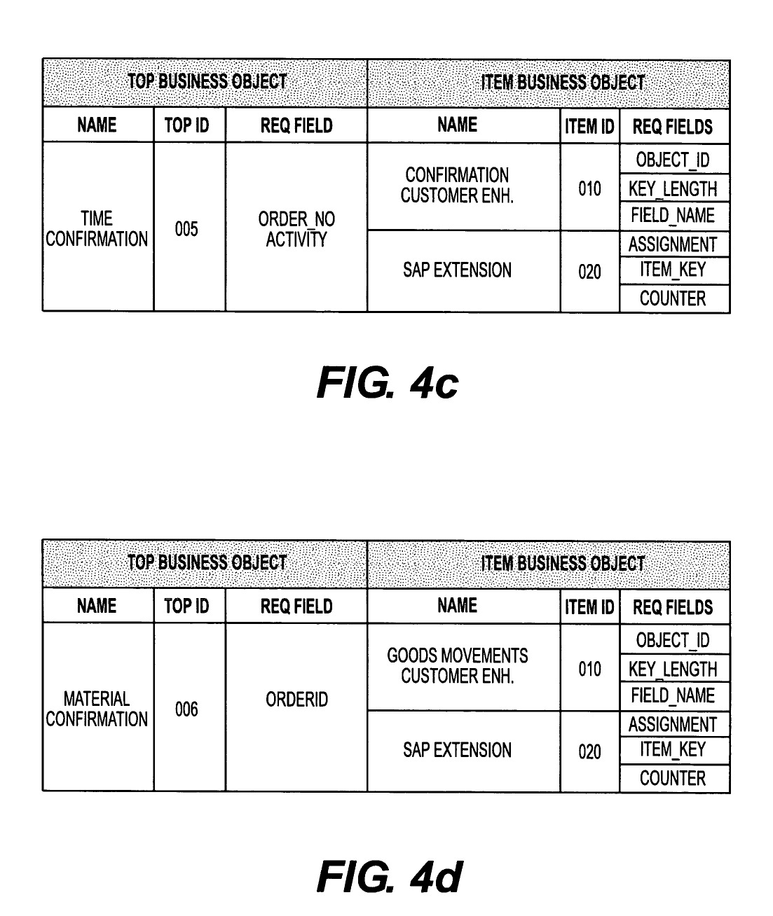

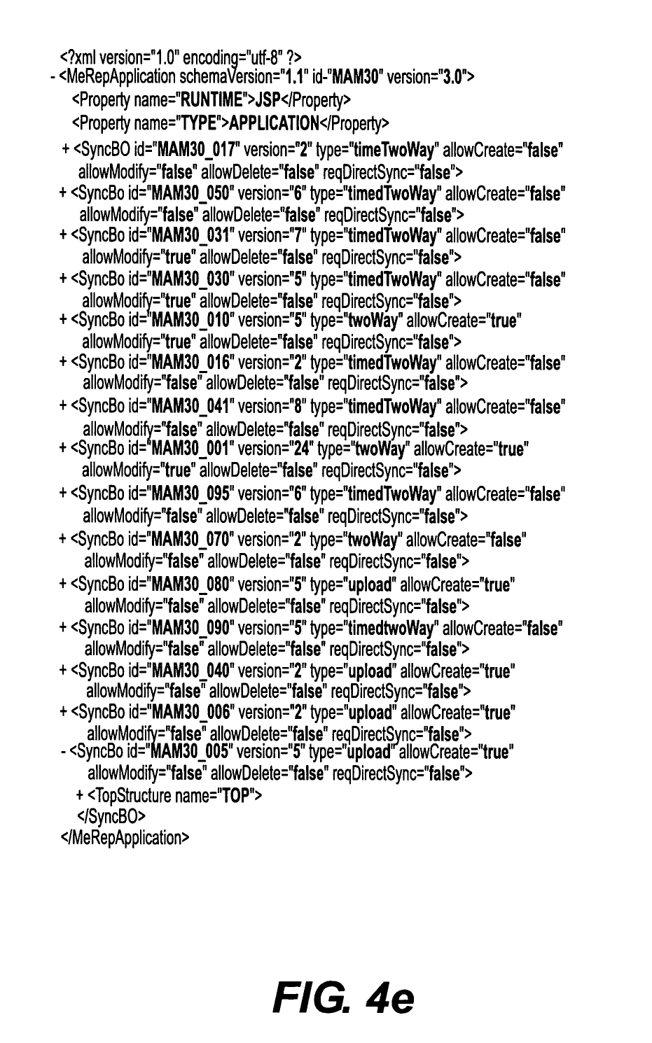

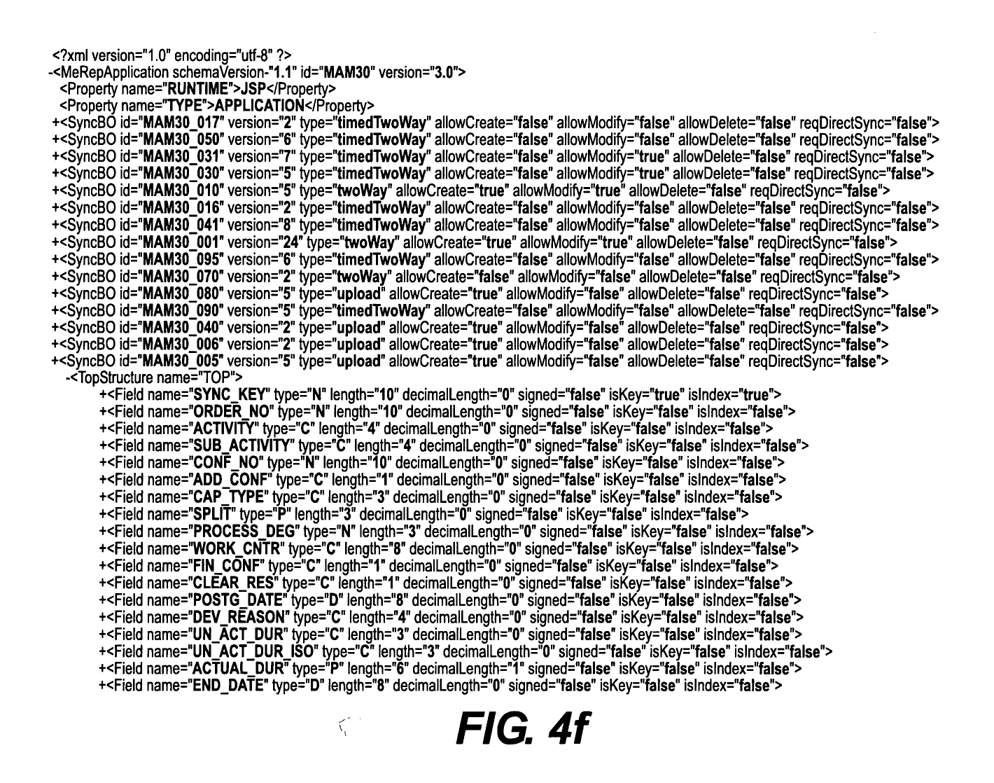

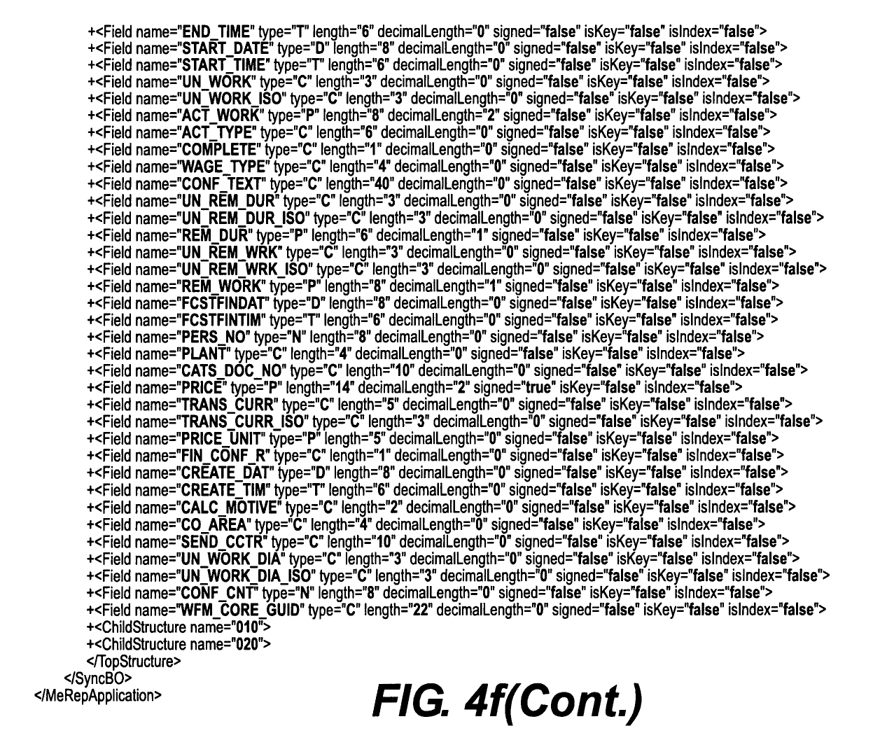

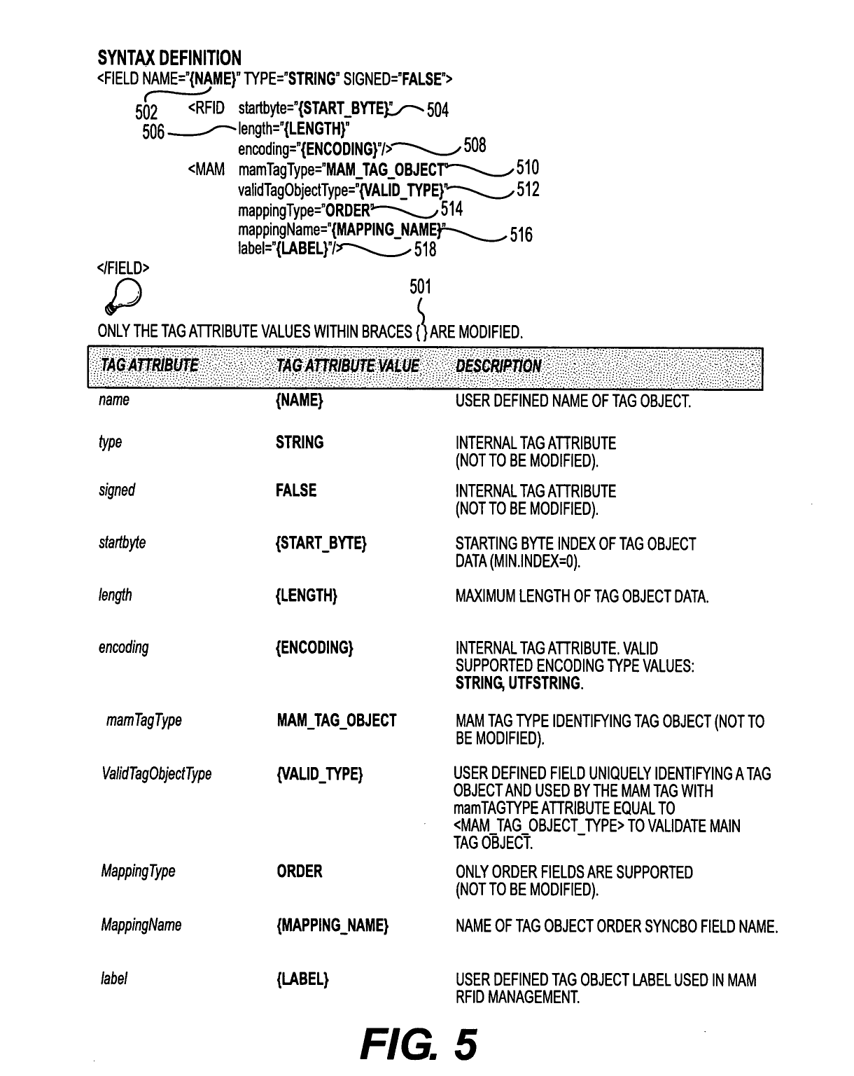

A set of RFID enhancement guidelines having, for example, definitions, syntaxes, and examples for tag structure definition may be provided to facilitate the user's customization of the initial tag structure and provide accesses to the user's business objects. In one suitable arrangement, the user's business objects may be specifically defined by the user, for example, in a business object data model. User definition of such a business object data model may take place prior to or concurrently with the customization of the initial tag structure file. This business object data model may include numerous top-level business objects and their associated item-level business objects that uniquely define the user's business. A detailed example of such a user-defined business object data model will be discussed below in connection with FIGS. 4a-4d. Examples of the various sections of the above enhancement guide are described in more details below in connection with FIGS. 5-18.

Once the user has successfully created a desirable customized tag structure using the enhancement guide and in view of the business object data model, a mapping engine and/or other suitable application, hereinafter referred to collectively as mapping engine, may interpret and map to data objects on an RFID tag based on the customized tag structure. Moreover, an authorized user may subsequently utilize the mapping engine to dynamically adjust and modify the tag content and structure. Such dynamic adjustments is described in more details below.

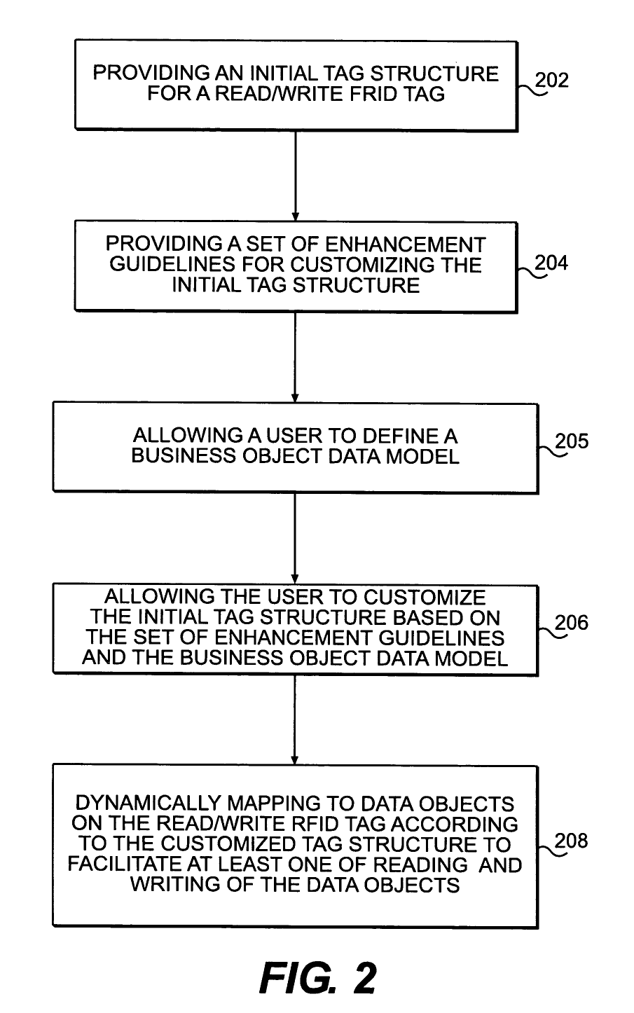

To provide a more detailed description of the above tag structure customization and tag mapping process, an exemplary flowchart showing the specific steps involved is illustrated in FIG. 2. At step 202, an initial tag structure may be provided to a user. As mentioned above, this initial tag structure may be tailored to the user's basic needs and requirements and may be provided as a part of a software package, as an add-on to a user application, as a downloadable application enhancement, or as any other suitable form of deliverable appropriate for such a file according to known technologies and techniques. Exemplary initial tag structure will be discussed in connection with FIG. 3 below.

Once an initial tag structure tailored to the user's basic needs has been provided, step 204 of the flowchart of FIG. 2 may be performed. Specifically, a set of enhancement guidelines for customizing the initial tag structure may be provided to the user to guide the user through customization of the tag structure. It will be understood that while step 204 is shown as been subsequent to step 202, the two steps may take place concurrently or in any other desirable order. Exemplary provision of the enhancement guidelines are illustrated and discussed in connection with FIGS. 5, 7, 9, 11, 13, 15, and 17 below.

As briefly mentioned above, the enhancement guide may be provided to facilitate the user's customization of the initial tag structure and provide accesses to the user's business objects. In one suitable arrangement, these business objects may be user-defined. Step 205 provides an opportunity for the user to define both top-level business objects and their associated item-level business objects, for example, in a business object data model. An example of such a business object data model will be discussed in connection with FIGS. 4a-4d.

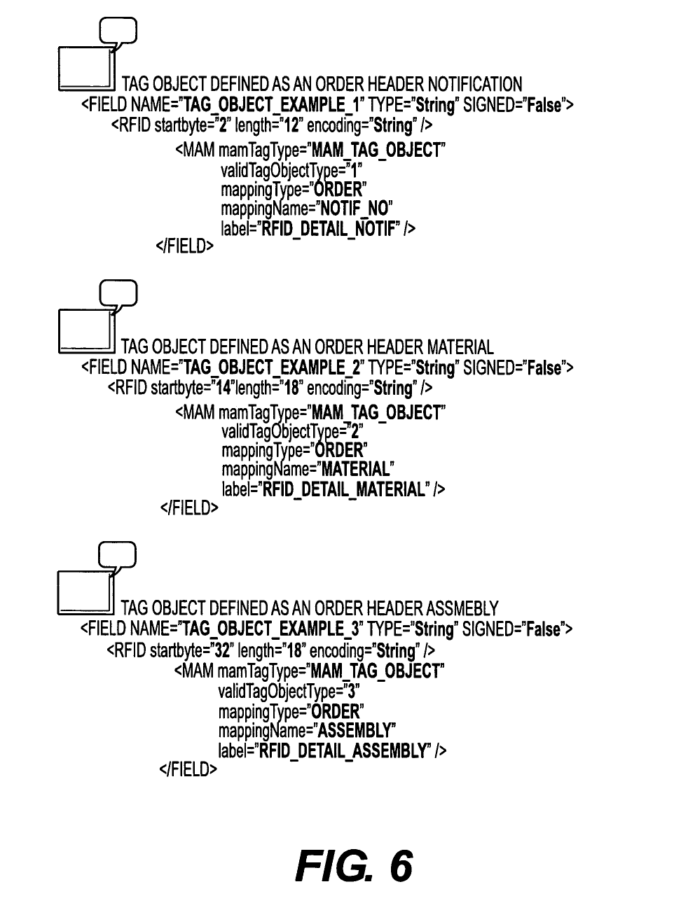

The user may customize the tag structure through enhancements based on the provided enhancement guidelines at step 206 in a similar fashion to examples given in FIGS. 6, 8, 10, 12, 14, 16, and 18 below. When the customized tag structure is complete, mapping of data objects on a read/write RFID tag may be performed at step 208 according to the customized tag structure and user-defined business object data model.

In one suitable arrangement consistent with the present example, mapping may be performed, for example, by a mapping engine in a field device of a maintenance technician. The field device may be a laptop, a PDA, or any other suitable device. The device may have attached to it or may be in communications with an RFID tag reader/writer. The technician may be required to scan (or read) the tag attached to, for example, an equipment or a group of equipment at a functional location, at a user-specified proximity. While the reader/writer may be capable of reading/writing from a distance, the user may require the technician to scan in a much closer range to ensure that the technician is onsite to inspect the problem.

Once scanned, the tag objects may be accessible to the mapping engine, which may subsequently utilize the customized tag structures of, for example, FIGS. 5, 7, 9, 11, 13, 15, and 17, and the user-defined business object data model of, for example, FIGS. 4a-4d, to interpret the tag objects. During interpretation, the mapping engine may further access other related information including corresponding orders, notifications, etc. that were made accessible, for example, as mapped to the tag object through related mapping names in the synchronization business object header file associated with the business object data model, which may have been downloaded to the technician's field device. In this way, the technician may automatically gain access to a plethora of information associated with the scanned equipment and/or functional location without performing active searches. The mapping engine may also prevent the technician from writing to protected areas of tags including areas containing tag identification information as discussed below in connection with FIG. 4.

The mapping engine may further require the technician to perform certain activities prior to writing maintenance history data to the writable history area of a tag. For example, if the history tag object was defined as having a date validation, the technician may be required to validate the date of maintenance prior to being permitted to record a maintenance history. In this way, the user may utilize the customized tag structure to instruct the mapping engine to not only track activities performed on an equipment or at a functional area, but also carry out monitoring, error proofing, and a variety of other duties without personnel assistance.

An exemplary initial tag structure is shown in FIG. 3. This specific example illustrates an asset management solution (such as Mobile Asset Management (MAM) software commercially available from SAP AG, WAIldorf, Germany) for customizing read/write RFID tag structures to facilitate monitoring of maintenance activities associated with certain tracked equipment. It will be understood that while this example is specific to the given solution, processes and methods for enabling the user to define the customizable tag structure may be applied to an array of other applications and operations. Specifically, it will be understood that specific syntax definitions including definition of particular data objects, names, sizes, and any other modifiable information associated with the RFID tag structure, may vary quite substantially depending on business requirements.

In the context of the example of FIG. 3, the underlying business requirement is to provide a customizable read/write RFID tag structure that would enable maintenance performed by technicians on equipment or a functional location, which may include a group of equipment, to be documented and tracked. In one suitable embodiment, an initial tag structure may be provided to the user initially in connection with the business requirement as described above. This initial tag structure may be defined in an XML file 302 (e.g., in a file titled RfidTagDef.xml) and deployed, for example, in the installation path directory of a software application. The file may require the creation of an RFID tag with a minimum size of, for example, 256 bytes (512 bytes for UTF-8 encoding) or any other suitable size. In one suitable arrangement, file 302 may include a table tag 304 of value identified by the label <MAM_RFID_TAG_TABLE>. Table tag 304 may be defined as including a protection area tag, which may be used to define the data areas that the read/write RFID tag is to be separated into and what level of protection each of the data areas is to receive. In this example, the read/write RFID tag is divided into two logical protection areas, including an RFID tag object area 306 containing tag object data and an RFID tag history area 308 containing tag history data. Area 306 containing tag object data, which is described in more detail below, may relate to identification of the underlying item, such as equipment or functional location, to which the tag is attached and may be made non-modifiable, for example, to the technicians, to preserve the integrity of such identification. On the other hand, area 308 containing tag history data, which is also described in more detail below, may be made modifiable, so that maintenance updates and other history information associated with the underlying item may be documented and stored as maintenance work are performed. It will be understood that the above protection areas are specifically created for the present solution, other protection areas may be created in a similar fashion to satisfy particular business requirements.

More specifically to the illustrated example, RFID tag object data in protection area 306 may include a main RFID tag object 310, an optional alternate RFID tag object 312, an RFID tag object type indictor 314, and an optional RFID tag object filter 316. In this example, the main RFID tag object 310 may be used to identify particular equipment or a functional location, which may refer to a location within the user's facility that includes multiple equipment.

As the name suggests, optional alternative RFID tag object 312 may be defined if the user so desires, but it is not required. In this example, optional alternative RFID tag object 312 may also be used to identify a particular equipment or functional area. In one suitable arrangement, optional alternative RFID tag object 312 may define an equipment within a function area identified by main RFID tag object 310.

Of the two remaining tag structure components in this protection area, mandatory RFID tag object type indicator 314 may indicate which tag object is the main RFID tag object while optional RFID tag object filer 316 may be optionally used to provide more information on the main RFID tag object. For example, optional filter 316 may specify a unique materials id associated with the main RFID tag object. While four specific components are described above in connection with the protection area for tag object data, any other suitable tag object data may be provided in a similar fashion within tag object area 306 to identify the underlying item.

Similarly, a few types of data may be defined in RFID tag history area 308, for example, to document work performed in connection with tag objects defined in the tag object area 306. The tag history data may include, for example, work center 318 indicating the work center to which the technician belongs, a personnel ID 320 associated with the technician, start date/time 322 specifying when the maintenance began, end data/time 324, deviation reason 326 describing the problem requiring maintenance, and confirmation text 328 including, for example, the technician's other comments. Any other suitable tag history data may be similarly defined.

Continuing with the example of FIG. 3, a set of exemplary enhancement guidelines for further allowing the user to more particularly track and document maintenance of equipment and/or functional locations through a customized tag structure are discussed below in connection with FIGS. 5-18. It will be understood that not all components of an initial tag structure, for example, as provided in FIG. 3, may be enhanced. Restrictions may be enforced based on business requirements or other considerations. The user customized enhancements may be provided in a separate user-defined file (e.g., in a file named ZRfidTagDef.xml) at step 206. For example, this separate file may be stored in the same directory as the initial file. During mapping of data objects on the read/write RFID tag, which will be described in more detail below, the user-defined enhancement file (e.g., a file named ZRfidTagDef.xml) may be used to override the provided initial file (e.g., RfidTagDef.xml) discussed above. In some suitable arrangements, the user defined file and the initial file may be used in conjunction to define the customized tag structure.

For the initial tag structure of FIG. 3, enhancements may be made, as shown in FIG. 4, to modify existing initial components or to introduce additional components. In the present example, the enhancements may include, for example, object data 402 and object filter 404 directed to enhancement of tag object data, and history data 408, history write data 410, history data appending 412, and history data validation 414 directed to enhancement of tag history data. Utility definitions object/history data zero removal 406/416, which are described in more detail below, may also be included. It will be understood that enhancements may vary substantially to suit the particular business requirements. It will also be understood that all enhancements are subject to the RFID tag byte storage size limitation. Specific syntax definitions as provided in the enhancement guide of step 204 of FIG. 2 in connection with each of the enhancements shown in FIG. 4 are described in more detail below.

As mentioned above, enhancement of initial tag structure may include providing connections and accesses between tag objects and their associated business objects in the user's operation. To facilitate provision of this type of access, the user may initially be provided with an opportunity to define those business objects that are particular to its operation, for example, in a business object data model. One example of such a business object data model is partially illustrated in FIGS. 4a-4d. In this particular example, fifteen top-level business objects 4a-1 are defined by the user in connection with its field maintenance operations. Each of the top-level business objects 4a-1 is shown in FIG. 4a with its respective assigned name 4a-2, business object id 4a-3, and primary key field 4a-4. During mapping, the mapping engine may locate a business object by referring to its unique business object id 4a-3. Each instance or entry of that business object 4a-1 may be identified by a particular primary key in the primary key field 4a-4.

Because business objects 4a-1 are top-level objects, they may each be associated with numerous item-level business objects. For illustration purposes, item-level business objects associated with three top-level business objects 4a-1 are shown in FIGS. 4b-4d. Specifically, in FIG. 4b, top-level business object order 4b-1 is shown as being associated with an array of item-level business objects 4b-2. Similar to the definition of top-level business objects, item-level business object may also have an associated item name 4b-3, a unique item id, which a mapping engine may use to refer to the item, and a required field 4b-4, which specifically refer to particular instances or entries of the item similar to the way primary key fields identify instances of top-level objects. In FIGS. 4c and 4d, item-level business objects associated with top-level business objects Time Confirmation and Material Confirmation are defined in the same fashion as discussed above.

As earlier mentioned, the initial tag structure and the replacement/enhance tag structure may be provided in suitable XML files stored, for example, in the installation path of a suitable application (e.g., the MAM application). Similarly, the user-defined business object data model may also be implemented in an XML file (e.g., meRepMetal.xml) to allow synchronization of the tag objects and the user's business objects. For example, a meRepMetal.xml file as shown in FIG. 4e may be provided in which top-level business objects 4a-1 from FIG. 4a may be referenced by their unique ids 4a-3 in SyncBO id field 4e-1. The top-level business objects as referenced by the SyncBO ids may be expanded, for example, by clicking on the plus sign 4f-1 to the left of the SyncBO id, as shown in FIG. 4f, to reveal their associated item-level business fields 4f-2. In this particular example, the last object 4f-3, referenced by SyncBO id 005, which corresponds to Time Confirmation in FIG. 4a, is shown in its expanded form, revealing the various associated attributes.

The user may subsequently reference or otherwise utilize these SyncBO fields to map information on the RFID tag to various information associated with the user's business objects. Specific utilization of the SyncBO fields and the mapping of the RFID tag objects to these fields will be discussed in more detail below in connection with the customization of the initial tag structure.

FIG. 5 shows a set of exemplary syntax definition guidelines for object data 402 discussed in connection with FIG. 4. As shown in this example, the syntax definition guidelines limits user definition to certain attributes, which are indicated as being modifiable by curly brackets 501. This restricted modification framework preserves tag integrity by ensuring vital data required for the tag objects to function properly are not changed by the user accidentally or mistakenly. In this example, the user may supply a name 502, which is of a required type string. The user may provide a startbyte 504 and length 506, for example, to indicate to a mapping engine used to access the data objects on the tag, where this particular data object begins and how long it is. Encoding 508 allows the user to specify a valid encoding type, such as string, UTFString, or any other suitable type to characterize the data object. To minimize errors, the user may be restricted to choose from certain provided encoding types.

The attribute manTagType 510 in this example indicates that this data object is of the non-modifiable type MAM_TAG_OBJECT. This non-modifiable type ensures that the mapping engine will correctly identify the tag object type and therefore know how to interpret the data object. The user, however, may supply a validTagObjectType 512, for example, selected from a group of available and/or user-defined tag object types, to uniquely identify the current tag object, which the mapping engine may use for validation purposes. Additionally, mappingtype 514 is set to the value “order” in the present example. An order in the context of this solution may refer to a maintenance order, such as a service maintenance order, a plant maintenance order, or any other type of maintenance order in connection with an equipment or functional area to which the tag is associated. This fixed attribute indicates that the present tag object is exclusively associated with maintenance orders.

While the user is prevented from defining the mappingtype, as discussed above, the user is allowed to supply the mappingName 516. Because the present example is exclusively directed to orders, the user-defined mappingName 516 may be used, for example, in the synchronization business object (e.g., having the name syncBO) header fields of an order to enable association of the related order to this tag object. The synchronization business object fields may be defined in another XML file (e.g., meRepMetal.xml), which may also be found in the MAM installation path as discussed above. These header fields may be used to provide a subset of the information associated with an order, including the mapped tag object, from a backend system to a field device such as a laptop or personal digital assistance (PDA) or other suitable field device of a technician. The backend system typically stores a comprehensive set of information associated with the order. The user may additionally define a label 518, for example, to describe the tag object. The label 518 may either be selected from a file of predefined descriptions or may be user defined.

FIG. 6 illustrates three examples of user-defined tag objects for various maintenance order-related data objects consistent with the customizable tag object syntax provided in FIG. 5. For example, TAG_OBJECT_EXAMPLE_{—}1 is defined as a MAM_TAG_OBJECT that is related to order notification, while TAG_OBJECT_EXAMPLE_{—}2 is defined as a MAM_TAG_OBJECT that is related to materials associated with orders, and TAG_OBJECT_EXAMPLE_{—}3 is defined as a MAM_TAG_OBJECT that is related to assembly associated with orders.

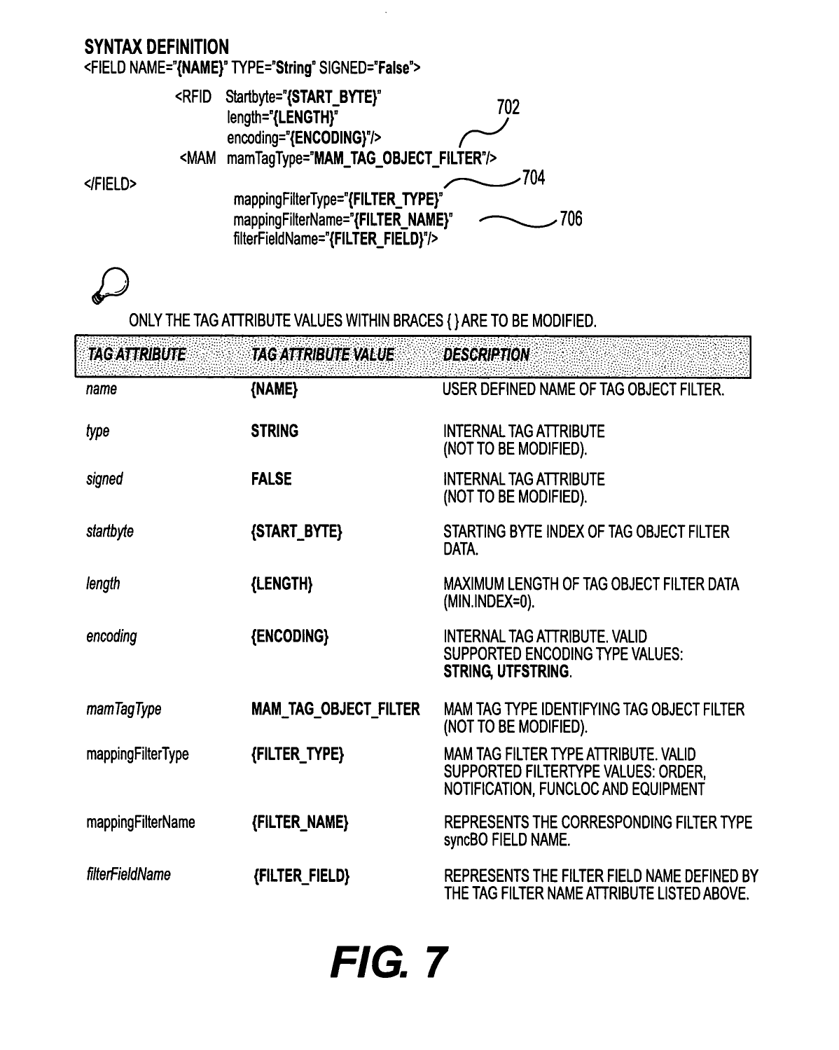

As previously mentioned, an RFID tag object filter 316 may be optionally introduced to store additional information, such as a material id, to uniquely identify the main RFID tag object 310. FIG. 7 shows one exemplary set of syntax definitions for such an RFID tag object filter 316, 404 in the context of the present example. Similar to the syntax definition shown in FIG. 5, only some of the attributes are made modifiable to the user and are shown in curly brackets. Notably, manTagType 702 is set to MAM_TAG_OBJECT_FILTER and is not to be modified. This ensures that this tag object will be easily identifiable as a tag object filter 404 during mapping.

Unlike the syntax definition of FIG. 5, which had a set mappingtype, the mappingFilterType 704 in the RFID tag object filter 404 may be user defined. In one suitable arrangement, the user may be allowed to select a tag filter type from a set of predefined types including, for example, ORDER indicating a maintenance order, NOTIFICATION indicating a maintenance notification generated prior to the generation of an order, FUNCLOC indicating a functional location having a group of equipment, or EQUIPMENT. The user may define a mappingFilterName 706 to represent and correspond to a filter type field name, for example, in the synchronization business object header fields of an order, notification, functional location, or equipment in a similar fashion as discussed above in connection with the definition of FIG. 5.

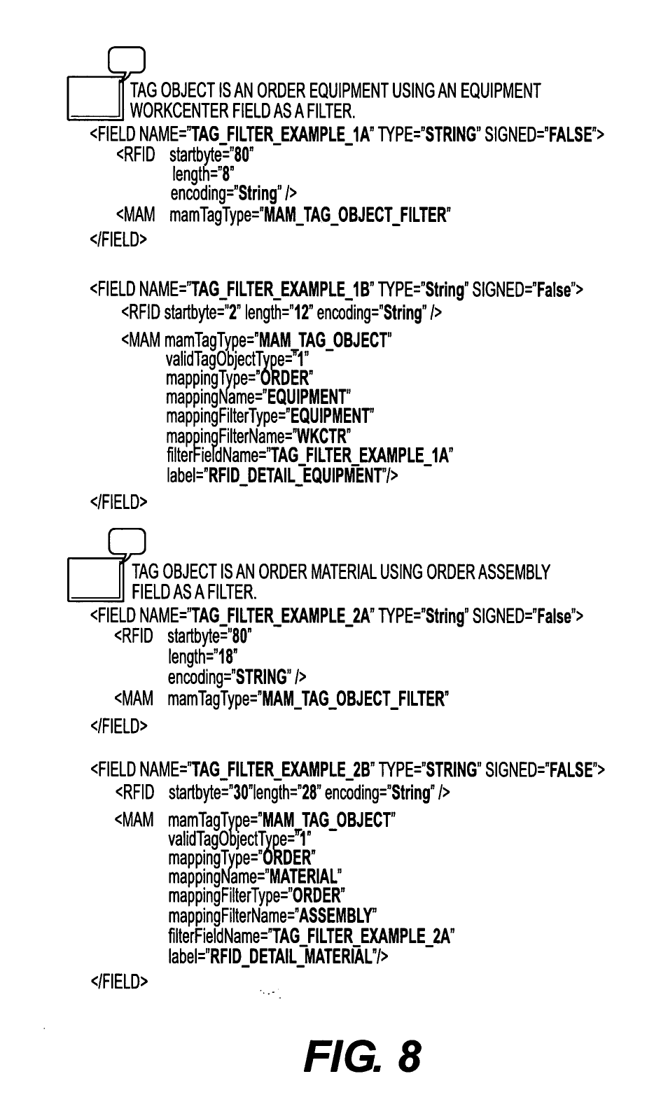

FIG. 8 shows two examples of user defined tag filter objects 404 in accordance with the tag filter structure provided in FIG. 7. For example, TAG_FILTER_EXAMPLE_{—}1A and 1B relate to a tag object that is an order equipment using an equipment work center field as a filter. As another example, TAG_FILTER_EXAMPLE_{—}2A is defined as a tag object that is an order material using order assembly field as a filter.

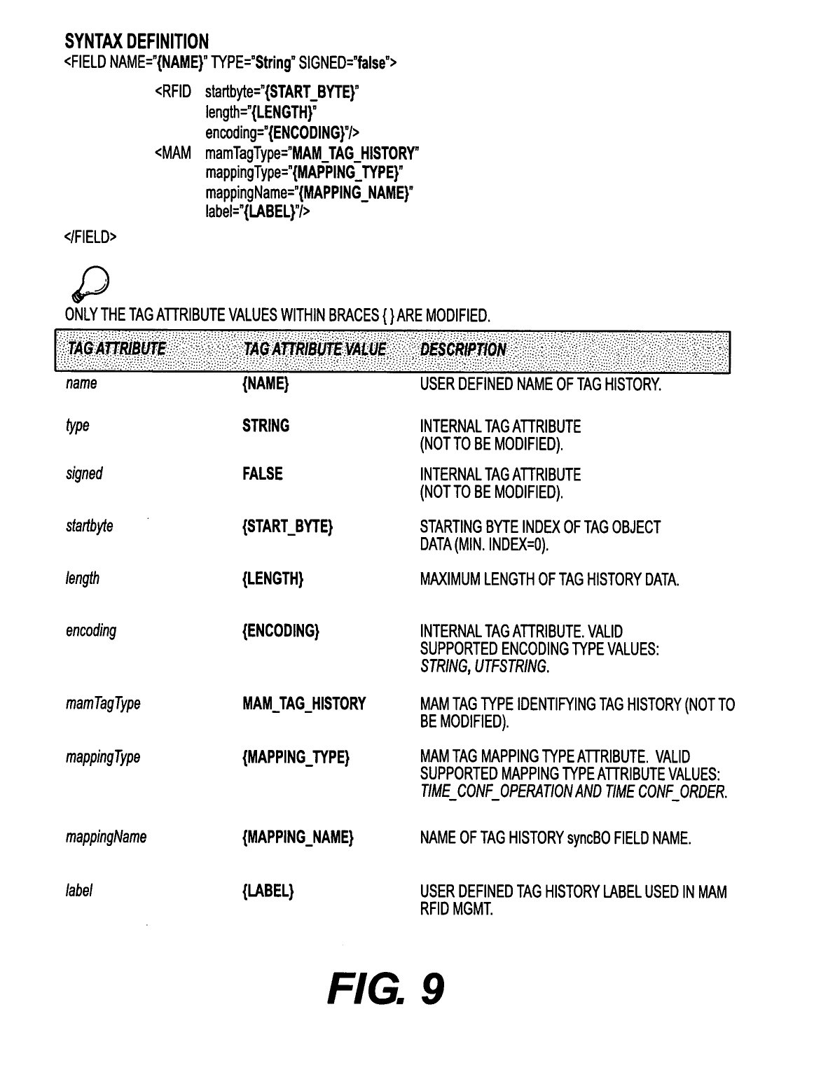

As mentioned above, RFID tag history data 308 may also be enhanced by enabling user definition. FIG. 9 shows an exemplary set of syntax definitions for a tag history object 408 consistent with the present example. Most of the attribute definitions are quite similar to those discussed above in connection with the tag object 310 definition and tag object filter 316 definition of FIGS. 5 and 7. The particular non-modifiable mamTagType 902 is preset as MAM_TAG_HISTORY. The mappingType 904 is user-defined and may be selected from a supported type attribute set including, for example, TIME_CONF, TIME_CONF_OPERATION, and TIME_CONF_ORDER. In the present example, TIME_CONF may refer to time confirmation, which may provide a snapshot of maintenance operation in progress. TIME_CONF_OPERATION, on the other hand, may be generated at the end of a maintenance operation. Finally, TIME_CONF_ORDER may be generated at the completion of a maintenance order encompassing more than one operations. The user may define the mappingName 906 that corresponds to a related field in the appropriate header file of, for example, a synchronization business object as discussed above. The header file may be associated with a time confirmation, an order, or an operation depending on the corresponding mappingType 904.

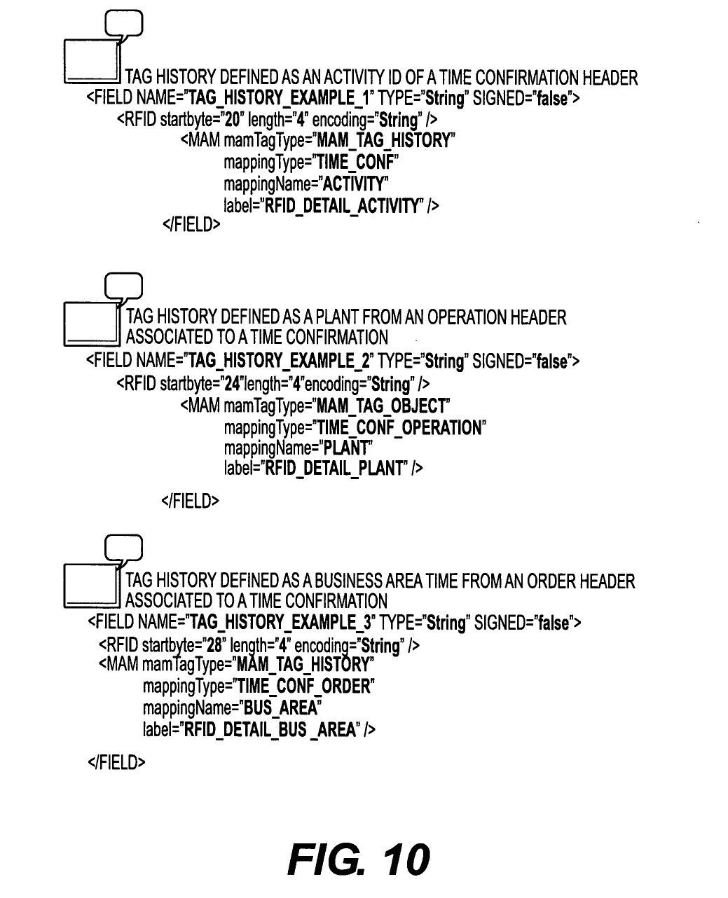

FIG. 10 shows three examples of user defined tag history objects based on the syntax definition of FIG. 9. For example, TAG_HISTORY_EXAMPLE_{—}1 is defined as an activity ID of a time confirmation header, TAG_HISTORY_EXAMPLE_{—}2 is defined as a plant from an operation header associated to a time confirmation, and TAG_HISTORY_EXAMPLE_{—}3 is defined as a business area time from an order header associated to a time confirmation.

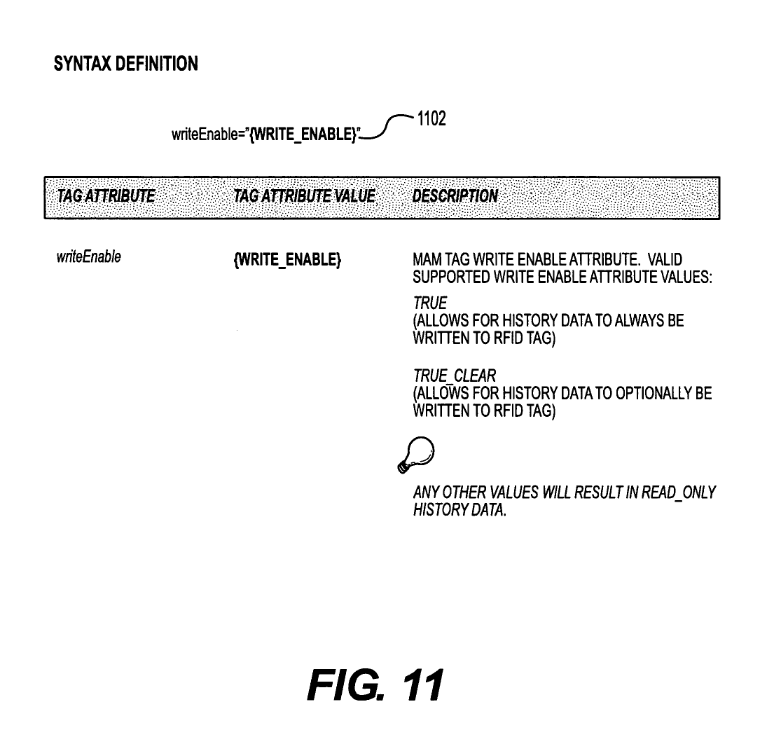

The tag history object as defined in FIG. 9 may be further enhanced through definitions of, for example, tag history write data, tag history data appending, tag history data validation, and history data zero removal, which are discussed below. FIG. 11 shows an exemplary syntax definition to enable writing to the tag history object as defined according to FIG. 9. Specifically, a new tag attribute writeEnable 1102 may be introduced. The attribute writeEnable 1102 may take on a value of “TRUE” to permit history data to always be written to the RFID read/write tag, for example, by the maintenance technician. On the other hand, if a value of “TRUE_CLEAR” is assigned to writeEnable 1102, history data may be optionally written to an RFID tag, for example, only when the technician has satisfied certain requirements such as having verified that he had supplied the correct history information. Any other values assigned to writeEnable 1102 may result in the history data becoming read-only.

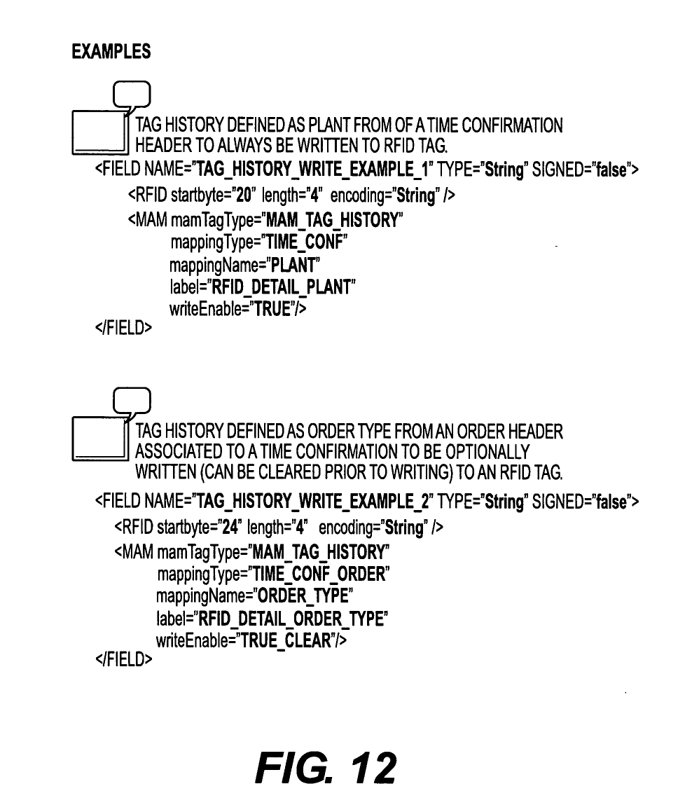

Two examples of write enhanced tag history definitions are shown in FIG. 12. For example, TAG_HISTORY_WRITE_EXAMPLE_{—}1 is defined so the plant data from a time confirmation header will always be written to an RFID tag and TAG_HISTORY_WRITE_EXAMPLE_{—}2 is defined so an order type from an order head associated with a time confirmation may optionally be written to an RFID tag.

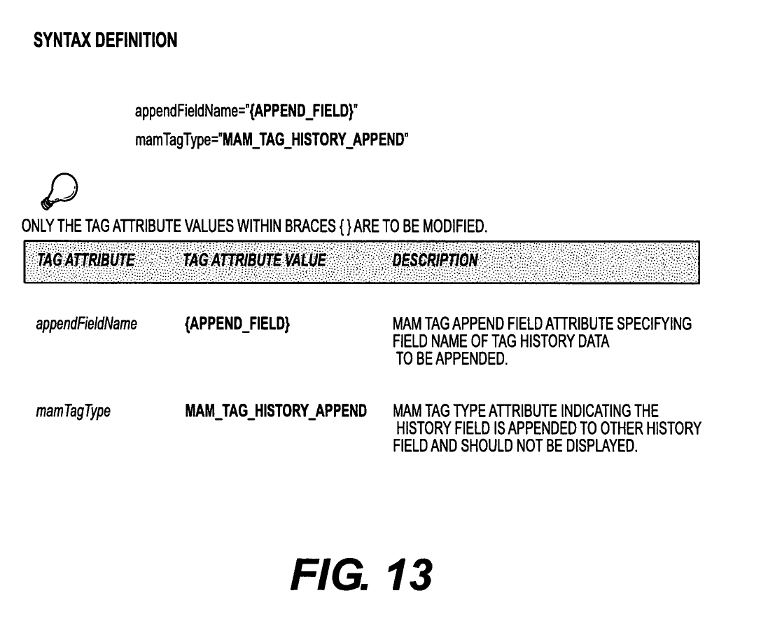

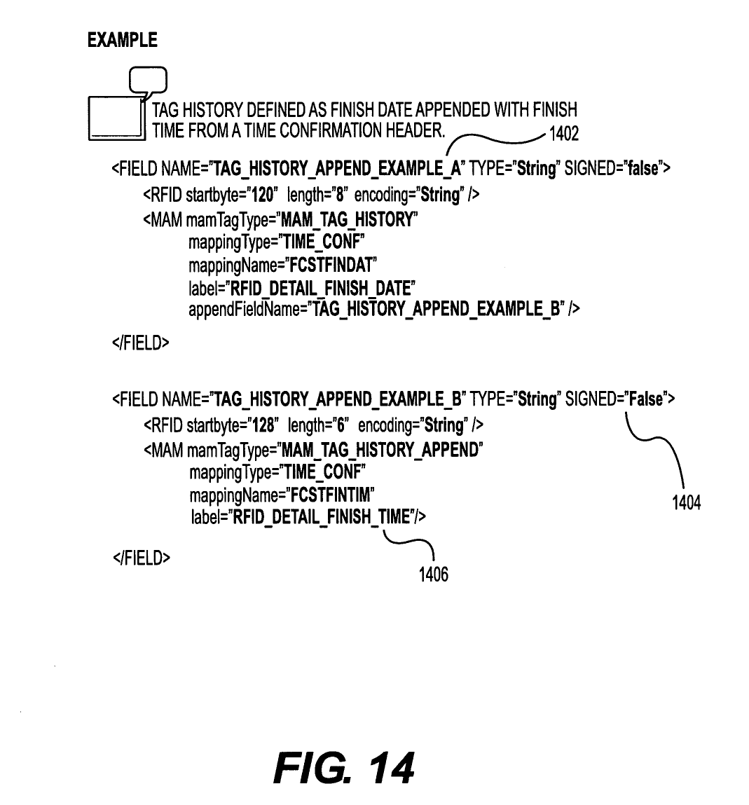

Tag history object as defined according to FIG. 9 may also be enhanced to become appendable to another history entry by including syntax definition for tag history append as shown in FIG. 13. In other words, the enhancement may allow one history entry to the attached to another related history entry. Specifically, an attribute appendFieldName 1302 may be incorporated to cause the current history field to be appended to the history field specified by appendFieldName 1302. Two examples of such appended fields are defined in FIG. 14. These two examples show that field 1402 is to be appended to field 1404, which is to be appended to a finish time 1406 (not shown).

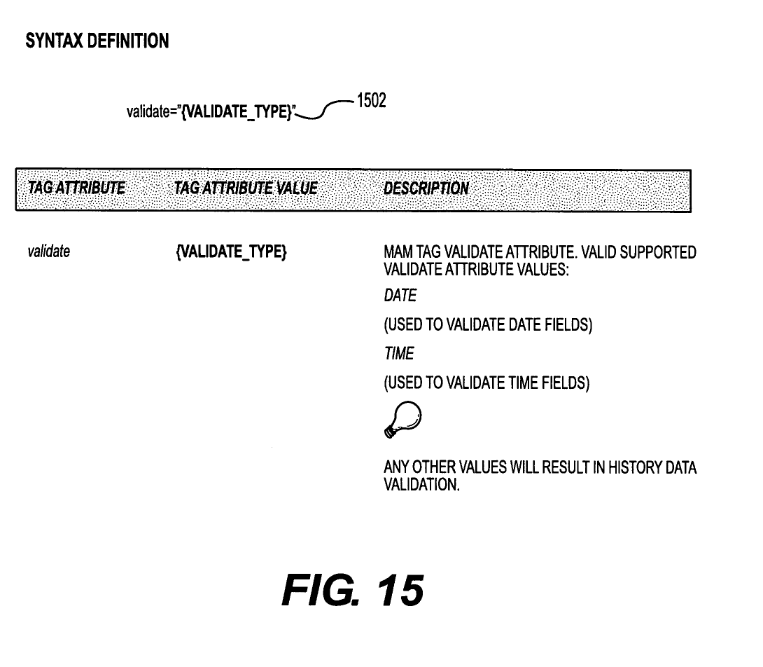

FIG. 15 shows syntax definition of a validate attribute 1502 that may be included in the definition of a tag history object 408 according to FIG. 9. The validate attribute may be chosen from a predefined group including, for example, DATE, TIME, or any other suitable attributes and may require that the specified attributes of a tag history object be validated before the history data is written to an RFID read/write tag.

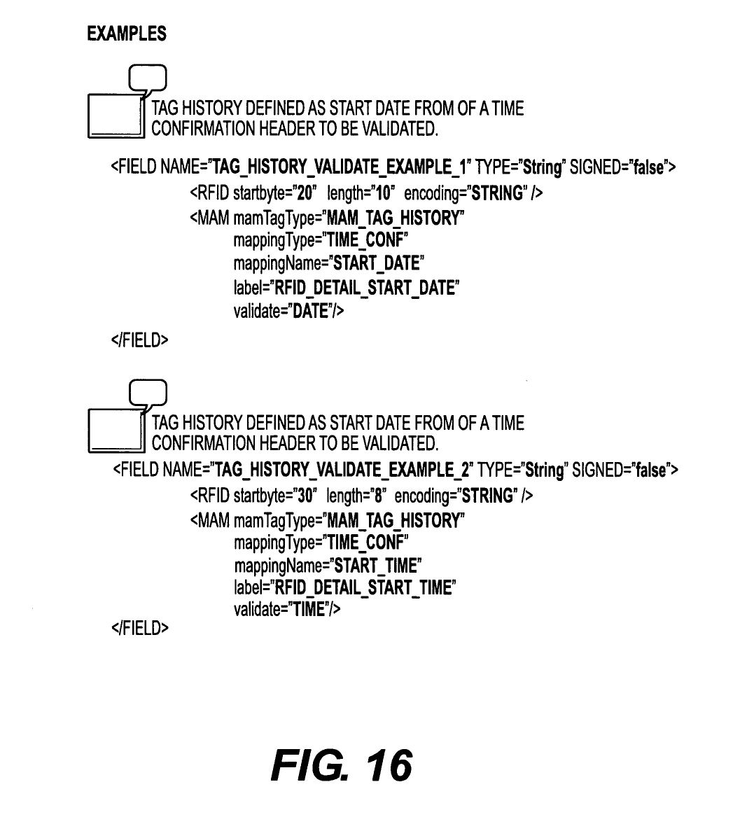

Examples showing definitions of tag objects having the validate attributes are shown in FIG. 16. For example, TAG_HISTORY_VALIDATE_EXAMPLE_{—}1 and TAG_HISTORY_VALIDATE_EXAMPLE_{—}2 require start dates from time confirmation headers to be validated.

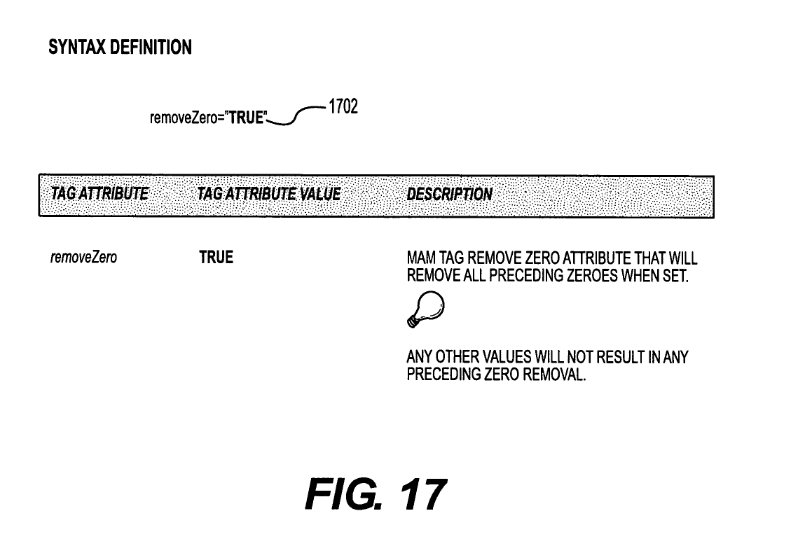

FIG. 17 shows an example of a utility enhancement of a tag history object 408 as defined according to FIG. 9. This utility enhancement may be useful when attributes are defined as having more space than is necessary to accommodate the current content (e.g., 10 digits defined while only 3 digits are used). In such cases, the 3 digit content may be written as being preceded by space filler zeros, which may cause comparison or other types of errors. The current enhancement attribute 1702, when set to “TRUE,” may remove the unnecessary zeros to prevent these types of errors. It will be understood that while only this specific utility enhancement is shown in the present example, any other utility enhancements may be implemented. It will also be understood that this type of utility enhancement may also be implemented in connection with a tag object as defined according to, for example, FIG. 5.

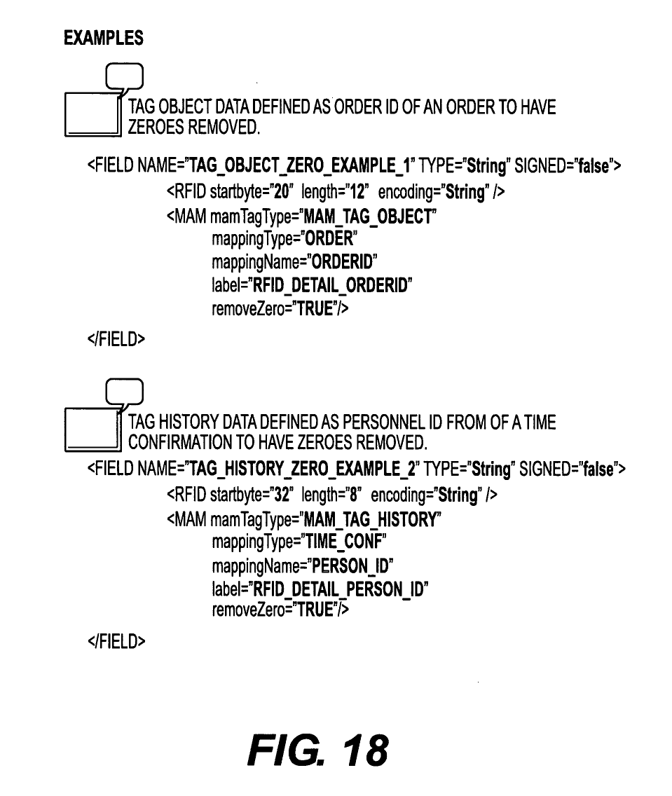

Two examples of user definition of history tag object having this utility enhancement is shown in FIG. 18. For example, TAG_OBJECT_ZERO_EXAMPLE_{—}1 enables filler zeros to be removed from an order ID of an order, while TAG_OBJECT_ZERO_EXAMPLE_{—}2 enables filler zeros to be removed from a personnel ID of a time confirmation.

While the above example is narrowly defined for a particular business requirement, the definition and mapping process of customizable RFID tag structures may be applicable to limitless number of business operations. In the following sections, some general applications in a limited number of supply chain areas are identified to illustrate the areas in which the above described invention may be applicable. This list is merely illustrated and not exhaustive of the types of operations that may benefit from the present disclosure.

Consistent with the principles of the present disclosure, customizable read/write RFID tag structures and dynamic mapping of data objects on a read/write RFID tag based on these customizable tag structures may be implemented in various operations throughout the supply chain network and beyond. Some exemplary applications and benefits of such implementations are discussed below.

In one suitable application, read/write tags having suitably customized tag structures may be used by manufacturers and other asset intensive operators to perform asset management activities. For example, read/write tags may be attached to capital equipment and other assets. Customized tag structures defined in the style consistent with the principles of the present disclosure but tailored to suit the users' specific needs may be provided on these tags to allow storage of information such as, for example, equipment service time, service instructions, requirements for service personnel, and any other suitable information. The manufacturer or equipment owner may subsequently scan the manufacturing space generally to identify equipment that are approaching service time. A mapping engine and its related application, in response to receiving the data stored on the tag and interpreting the data using the user's customized tag structures, may, for example, create charts illustrating upcoming service schedules or may generate alerts for fast approaching service dates of specific equipment. Service personnel, when servicing a tagged equipment may also access servicing instructions stored on the tag through mapping of the data objects on the tag according to the customized tag structure. The service instructions may be made modifiable or unmodifiable to the service personnel, for example, based on the service personnel's authorization as determined according to the user's requirements. Additionally, for large manufacturing facilities having mobile equipment, the customized tag structure may define a location variable for each tracked equipment. In this way, the mapping engine may easily locate the equipment for future use. Many other suitable applications may be developed using the customizable tag structure to allow dynamically mapping to data objects and a tag and the performance of activities based on the interpretation of those data objects.

Read/write tags associated with customizable data structures consistent with the principles of the present disclosure may also be applied in a production setting. For example, read/write tags having structures defining part numbers, assembly instructions, and other production information may be attached to various unfinished product parts and grouped by production needs into different protection areas with different protection designations. For example, part numbers may be made non-modifiable, while production information such as current state of assemble may be rewritten or revised to reflect current state of production. A mapping engine and its related application upon processing and interpreting tag data objects received from scans of the assembly line and through mapping based on the customized tag structures, may determine, for example, if all the appropriate parts are in correct proportion for production so a desired number of finished products may be assembled. An assembly worker, upon scanning a particular part, may be informed of the proper procedures for assembling the item and may be allowed to write a status to the read/write tag. However, the worker may be prevented by the mapping engine through interpretation of the customized tag structure from modifying the assembly instructions.

Read/write tags having customized data structures and the corresponding mapping engine may additionally be very useful in inventory control, where RFID tags have become common place. In addition to known uses of read-only or very restrictive use of read/write tags, which are generally limited to utilization of a basic code associated with an inventory item to track the item, read/write tags having customized tag structures consistent with the principles of the present disclosure may be introduced to provide further functionalities. For example, customized tag structures may include data definitions for, for example, storage instructions for warehousing facilities, data objects in which the logistics company may update transit information, and/or include any other information that may be accessed and/or modified by various participants in the supply chain. The various participants may be unrelated and unaware of each other's inventory structures. The mapping engine maps to and interprets the tag objects based on the customized tag structure such that, each of these organizations may gain access to appropriate data objects on the tag as permitted by the user. In this way, manufacturers, distributors, logistics providers, and retailers may all use and update the same tag for inventory management applications.

Many additional applications of customizable tag structures may be implemented to benefit a variety of operations in which identification and/or tracking of items are desirable. As varied as these applications may be the underlying customizable tag structure and dynamic mapping of data objects on a read/write tag based on the customized tag structure share the same spirit consistent with the principles of the present disclosure. The power and flexibility of such an initial data structure lies in the framework within which the particular users may customize or define data objects to suit their unique needs.

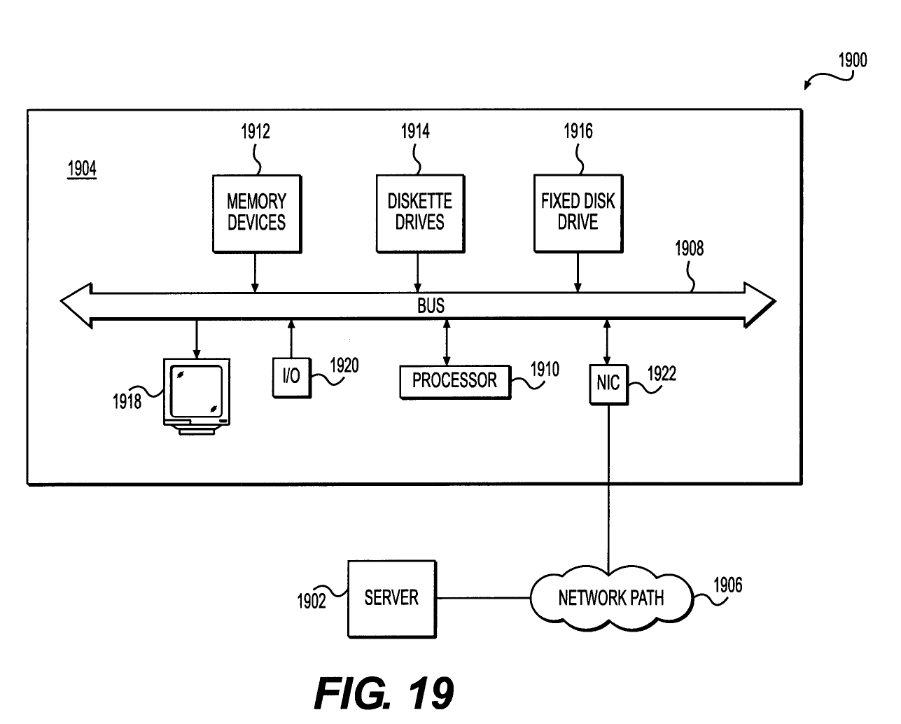

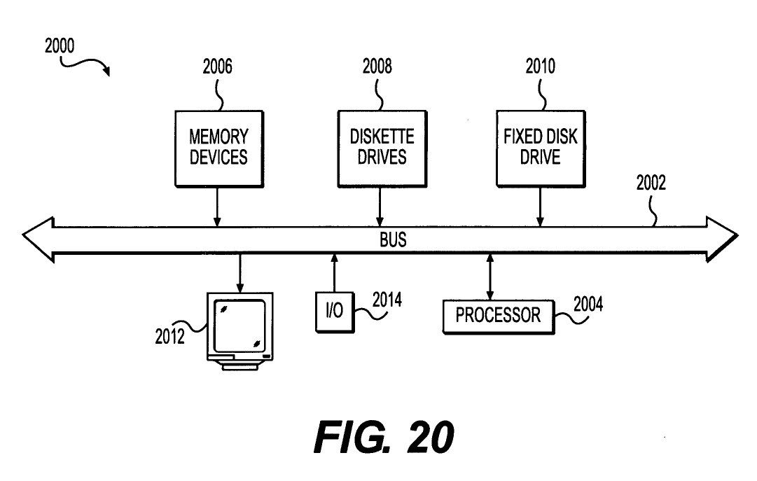

A computer system may be used to install a software application implementing a system and method for allowing a user to customize tag structures of a read/write RFID tag and for dynamically mapping to data objects on a read/write tag based on the customized tag structures consistent with the principles of the present disclosure. The computer system may be a computer network, as shown in FIG. 19, or a stand-alone personal computer (PC), as shown in FIG. 20.

As shown in FIG. 19, a computer network 1900 in accordance with systems consistent with the principles of the present disclosure may include a server 1902 and a stand-alone PC 1904 connected through a network path 1906. Computer network 1900 may be a local area network (LAN), where server 1902 and PC 1904 are workstations. Computer network 1900 may also be the Internet, with server 1902 hosting a web application and PC 1904 being any workstation available to a user desiring to interface with the application on server 1902. Alternatively, computer network 1900 may be a wide area network (WAN) (e.g., a packet or circuit switched network), and server 1902 and PC 1904 may lie in two separate LANs connected through a suitable network (e.g., a virtual private network (VPN) using the Internet).

PC 1904 may include a bus line 1908 connecting a plurality of devices such as a processor 1910, memory devices 1912 for storage of information, diskette drives 1914, a fixed disk drive 1916, a monitor or display 1918, other I/O devices 1920, and a network interface card (NIC) 1922. Processor 1910 may be a microprocessor such as an Intel Pentium™ chip for processing applications. Memory devices 1912 may include read-only memories (ROM) and/or random access memories (RAM). Diskette drives 1914 may include a floppy drive and/or a compact disk (CD) drive. Fixed disk drive 1916 may be a hard drive. I/O devices 1920 may include a keyboard and/or a mouse for receiving input from a user of PC 1904. Monitor or display 1918 may display output from processor 1910, and may also echo the input of the user. PC 1904 may be connected to network path 1906 through NIC 1922.

A web application may be installed on server 1902. An individual desiring to enter data into the application on server 1902 may use a web browser loaded on PC 1904, and may communicate with server 1902 through NIC 1922 and network path 1906. In one aspect, software application for implementing a system consistent with the principles of the present disclosure may be stored in PC 1904 and processor 1910 of PC 1904 may execute the software application locally within PC 1904 and interface with a web application on server 1902. Particularly, the software application may be stored on a floppy disk, a CD, or any other suitable readable media, which may be accessible by diskette drive 1914, fixed disk drive 1916, or any other suitable mechanism. In another aspect, the software application for implementing a system consistent with the principles of the present disclosure may be stored in server 1902, which may execute the software application, and processor 1910 of PC 1904 may communicate with server 1902 to send information to server 1902 and retrieve the results of the execution of the software application from server 1902.

Through the execution of the software application implementing a system consistent with the principles of the present disclosure, either locally within PC 1904 or remotely within server 1902, an interface or screen may be provided on a user display.

Alternatively, as shown in FIG. 20, a stand-alone PC 2000 may be used for implementing a software application implementing a system consistent with the principles of the present disclosure. PC 2000 may include a bus line 2002 connecting a plurality of devices, which may include a processor 2004, memory devices 2006 for storage of information, diskette drives 2008, a fixed disk drive 2010, a monitor or display 2012, and other I/O devices 2014. Processor 2004 may be a microprocessor such as an Intel Pentium™ chip for processing applications. Memory devices 2006 may include ROM and/or RAM. Diskette drives 2008 may include a floppy drive and/or a compact disk (CD) drive. Fixed disk drive 2010 may be a hard drive. Monitor or display 2012 may display the output of processor 2004 and may also echo the input of the user. I/O devices 2014 may include a keyboard and/or a mouse for receiving input from a user of PC 2000.

A software application implementing a system consistent with the principles of the present disclosure may be stored on a floppy disk or a CD accessible by diskette drive 2008 or on fixed disk drive 2010. Processor 2004 may execute the software application stored in the floppy disk the CD or the fixed disk drive 2010. An individual, through monitor or display 2012 and I/O devices 2014, may interact with processor 2004, which may execute the software application. A software application implementing a system consistent with the principles of the present disclosure may be written in any number of programming languages, including but not limited to JavaScript, Visual Basic, Flash, ABAP coding, or any other suitable language. Similarly, the present disclosure is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present disclosure has been described in connection with various embodiments, many modifications will be readily apparent to those skilled in the art. One skilled in the art will also appreciate that all or part of the systems and methods consistent with the present disclosure may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead are defined by the appended claims and equivalents.

What is claimed is:

1. A method for mapping of data objects on a read/write RFID tag, the method comprising:
providing an initial tag structure for the read/write RFID tag;
providing a set of enhancement guidelines for customizing the initial tag structure;
allowing a user to define a business object data model;
allowing the user to customize the initial tag structure based on the set of enhancement guidelines and the business object data model; and
dynamically mapping to data objects on the read/write RFID tag based on the customized tag structure to facilitate at least one of reading and writing of at least one data object.

2. The method of claim 1, wherein the initial tag structure includes designation of protection areas for different types of data objects on the read/write RFID tag, wherein rewriting of at least one data object is prevented in at least one of the protection areas.

3. The method of claim 1, wherein customizing the initial tag structure comprises overriding syntax definitions associated with the initial tag structure with user-defined syntax definitions.

4. The method of claim 1, wherein customizing the initial tag structure comprises modifying syntax definitions associated with the initial tag structure with user-defined syntax definitions.

5. The method of claim 1 wherein the business object data model includes both top-level business objects and item-level business objects associated with the top-level business objects.

6. The method of claim 1 wherein dynamically mapping to data objects on the read/write RFID tag comprises identify a business object in the business object data model and mapping the business object to a corresponding data objects on the read/write RFID tag based on the customized tag structure.

7. The method of claim 6 wherein the mapping is based on a mapping name.

8. A system for dynamically mapping of data objects on a read/write RFID tag, the system comprising:
an I/O device;
a display; and
a processor configured to:
provide an initial tag structure for the read/write RFID tag;
provide a set of enhancement guidelines for customizing the initial tag structure;
allow a user to define a business object data model;
allow the user to customize the initial tag structure based on the set of enhancement guidelines and the business object data model; and
dynamically map to data objects on the read/write RFID tag based on the customized tag structure to facilitate at least one of reading and writing of at least one data object.

9. The system of claim 8, wherein the initial tag structure includes designation of protection areas for different types of data objects on the read/write RFID tag, wherein rewriting of at least one data object is prevented in at least one of the protection areas.

10. The system of claim 8, wherein the processor is further configured to override syntax definitions associated with the initial tag structure with user-defined syntax definitions.

11. The system of claim 8, wherein the processor is further configured to modify syntax definitions associated with the initial tag structure with user-defined syntax definitions.

12. The system of claim 8 wherein the business object data model includes both top-level business objects and item-level business objects associated with the top-level business objects.

13. The system of claim 8 wherein the processor is further configured to identify a business object in the business object data model and mapping the business object to a corresponding data objects on the read/write RFID tag based on the customized tag structure.

14. The system of claim 13 wherein the mapping is based on a mapping name.

15. A computer-readable medium including instructions for performing, when executed by a processor, a method for dynamically mapping of data objects on a read/write RFID tag, the method comprising:
providing an initial tag structure for the read/write RFID tag;
providing a set of enhancement guidelines for customizing the initial tag structure;
allowing a user to define a business object data model;
allowing the user to customize the initial tag structure based on the set of enhancement guidelines and the business object data model; and
dynamically mapping to data objects on the read/write RFID tag based on the customized tag structure to facilitate at least one of reading and writing of at least one data object.

16. The computer-readable medium of claim 15, wherein the initial tag structure includes designation of protection areas for different types of data objects on the read/write RFID tag, wherein rewriting of at least one data object is prevented in at least one of the protection areas.

17. The computer-readable medium of claim 15 further includes instructions for overriding syntax definitions associated with the initial tag structure with user-defined syntax definitions.

18. The computer-readable medium of claim 15 further includes instructions for modifying syntax definitions associated with the initial tag structure with user-defined syntax definitions.

19. The computer-readable medium of claim 15 wherein the business object data model includes both top-level business objects and item-level business objects associated with the top-level business objects.

20. The computer-readable medium of claim 15 further includes instructions for identifying a business object in the business object data model and mapping the business object to a corresponding data objects on the read/write RFID tag based on the customized tag structure.
